(19) United States
(12) Patent Application Publication
(10) Pub. No.: US 2003/0224658 A1
(43) Pub. Date: Dec. 4, 2003

(54) Electrical connector

(76) Inventors: Richard Koch, Wakefield, MA (US); Anthony Martiniello, Wilmington, MA (US)

Correspondence Address: Grossman, Tucker, Perreault & Pfleger, PLLC, Suite 604, 795 Elm Street, Manchester, NH, 03101, US

(21) Appl. No.: 10/158,597

(22) Filed: May 30, 2002

(51) Int. Cl. H01R 9/05

(52) U.S. Cl. 439/582

(57) ABSTRACT

An electrical connector including a body with a mating connector end and a cable receptacle end having a cable opening therein for receiving at least a portion of a transmission line cable. A center conductor pin disposed in the connector body includes a receptacle structure having portions defining a receptacle opening extending therethrough. The receptacle opening is dimensioned for receiving a center conductor of the cable or an adapter pin.

### FIELD OF THE INVENTION

The present invention relates in general to electrical connectors, and in particular to an electrical connector having a center conductor pin for forming a press-fit electrical connection with a transmission line cable.

### BACKGROUND OF THE INVENTION

Coaxial cable connectors are, of course, widely known and used for making connection between coaxial cable assemblies, or from a coaxial cable assembly to electrical equipment. Those skilled in the art recognize, however, that the process of affixing a coaxial cable connector to a cable assembly can be cumbersome and time consuming. The assembly method varies with the type of connector assembly used. Typically, the cable must be stripped to expose the cable center conductor. The center conductor may then be soldered or crimped to a center conductor of the connector. Once the cable center conductor is soldered to the center conductor of the connector, the cable braid may be secured to the connector and a shrink-wrap dielectric may be installed over the braid. An end portion of the connector may then be mechanically secured to a body portion of the connector to complete the assembly.

Certainly, each of the assembly steps in attaching a coaxial cable connector to a coaxial cable must be completed accurately by a trained individual. The laborious assembly process adds to the manufacturing cost of the assembly, and thus to the end cost of the assembly to a consumer. The soldering step, in particular, requires time and expertise to ensure an appropriate electrical connection between the cable and the connector. Failure to make a reliable electrical connection between the cable center conductor and the connector center conductor can defeat the utility of the assembly. Worse yet, if the connection is intermittent, then intermittent electrical energy may be supplied on the cable assembly during use. This can result in damage to equipment and/or personal injury, especially in high-power radio frequency applications.

There is therefore a need for a coaxial connector that allows for facile and reliable connection to a coaxial cable.

### SUMMARY OF THE INVENTION

An electrical connector consistent with the invention generally includes a body including a connector end configured to mate with a mating connector and a cable receptacle end having a cable opening therein for receiving at least a portion of a transmission line cable, such as a coaxial cable. A center conductor pin is disposed in the connector body. The center conductor pin includes a receptacle structure having portions defining a receptacle opening extending therethrough. The receptacle opening is aligned with the cable opening and is dimensioned for receiving a conductor to make electrical contact between the conductor and the center conductor pin. The conductor may be a center conductor of the cable or an adapter pin electrically connected to the center conductor of the cable.

One exemplary method of electrically connecting a cable connector to a transmission line cable consistent with the invention includes: providing the connector with a connector body including a cable receptacle end having a cable opening therein for receiving at least a portion of the cable; providing a center conductor pin in the body, the center conductor pin including a receptacle structure having portions defining a receptacle opening extending therethrough; and inserting the center conductor of the cable into the receptacle opening through the cable opening.

Another method of electrically connecting a cable connector to a transmission line cable consistent with the invention includes: electrically connecting a first end of an IQ adapter pin to a center conductor of the cable; providing the connector with a connector body including a cable receptacle end having a cable opening therein for receiving at least a portion of the cable; providing a center conductor pin in the body, the center conductor pin including a receptacle structure having portions defining a receptacle opening extending therethrough, the receptacle opening being configured to receive a second end of the adapter pin; and inserting the adapter pin into the opening.

### BRIEF DESCRIPTION OF THE DRAWING

For a better understanding of the present invention, together with other objects, features and advantages, reference should be made to the following description of the preferred embodiment which should be read in conjunction with the following figures wherein like numerals represent like parts:

FIG. 1: is a side sectional view of an exemplary connector assembly consistent with the invention;

FIG. 2: is a bottom view of the exemplary connector illustrated in FIG. 1 with a bottom cover removed;

FIG. 3: is an end view of the connector illustrated in FIG. 1 showing an opening in a center conductor pin for receiving a cable center conductor consistent with the invention;

FIG. 4: is top view of an exemplary center conductor pin consistent with the invention;

FIG. 5: is a side view of the exemplary center conductor pin illustrated in FIG. 4;

FIG. 6: is a bottom view of the exemplary center conductor pin illustrated in FIG. 4.

FIG. 7: is a side, partial-sectional view of an exemplary connector and coaxial cable assembly consistent with the invention showing a center conductor of the coaxial cable extending into a center conductor pin of the connector;

FIG. 8: is a side sectional view of an exemplary connector assembly consistent with the invention incorporating an adapter pin consistent with the invention;

FIG. 9: is a side view of an adapter pin consistent with the invention affixed to a center conductor of a coaxial cable; and

FIG. 10: is side, partial-sectional view of an exemplary connector and coaxial cable assembly consistent with the invention showing an adapter pin connected to a center conductor of the coaxial cable and extending into a center conductor pin of the connector.

### DETAILED DESCRIPTION

The present invention will now be described in connection with an exemplary embodiment. The exemplary embodiment described herein is configured as a right angle connector. Those skilled in the art will recognize, however, that the advantages of the invention could be incorporated into many connector configurations. It is intended, therefore, that the invention not be limited to the specific embodiment described, but include any variation thereof associated with use in varied connector schemes and designs.

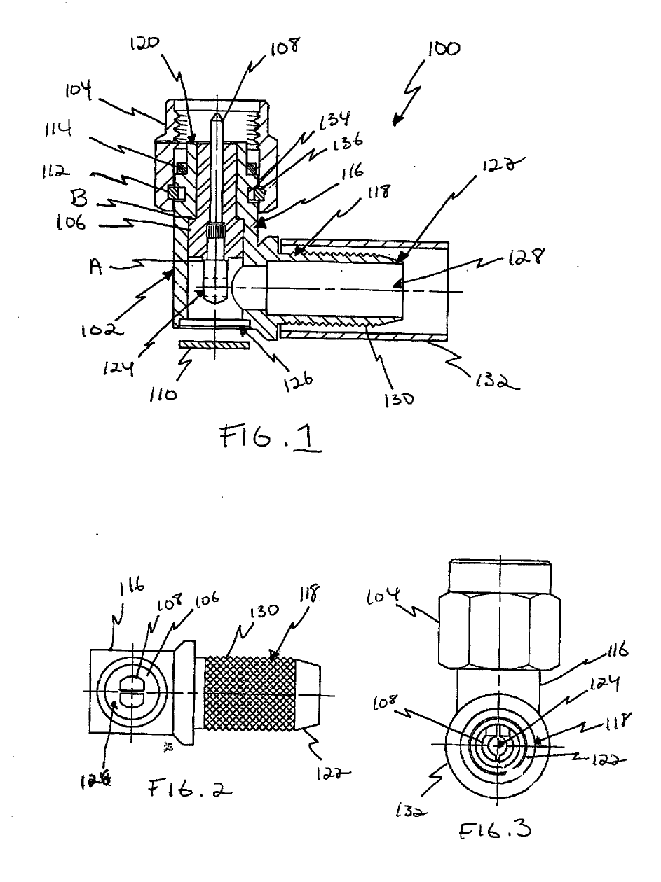

Turning to FIG. 1, an exemplary embodiment 100 of a connector consistent with the invention generally includes: a connector body 102, a coupling nut 104; a dielectric insulator 106; a center conductor pin 108; a cover 110; a retaining gasket 112 between the coupling nut and the body, and a gasket 114. In the illustrated exemplary embodiment, the body 102 includes a connector portion 116 configured at a right angle to a cable receptacle portion 118, thus establishing a right angle connector configuration with a connector end 120 and a cable-receiving end 122. Those skilled in the art will, of course, recognize that the features of the present invention are not limited right angle connectors, but may be incorporated into a variety of straight and angular connector configurations.

The body may be formed as an integral structure or from multiple separate and interconnecting portions. A variety of other construction and assembly configurations are possible. For example, the connector portion 116 may be constructed separately from the cable receptacle portion 118, and then joined thereto during assembly, as shown for example in FIG. 8. In one embodiment, the body 102, coupling nut 104, and cover 110 may be machined from brass and plated with nickel. The center conductor pin may be formed from brass and plated with silver. The insulator portions may be formed from a known insulating material such as TEFLON.

In the illustrated exemplary embodiment, the center conductor pin 108 includes portions defining a receptacle opening 124 at an end thereof. The opening 124 is dimensioned for receiving a center conductor of a cable, or an adapter pin affixed to the cable center conductor. When the cable center conductor pin, or an adapter pin affixed thereto, is disposed in the opening 124 an electrical connection is made between the center conductor pin 108 and the cable center conductor. Advantageously, the electrical connection is made simply by inserting the cable center conductor, or the adapter pin attached thereto, into the opening 108. No soldering is required to make the electrical connection between the pin 108 and the center conductor or adapter pin. This significantly reduces assembly effort, while ensuring a reliable electrical connection.

With reference also to FIG. 2, the body 102 includes an assembly opening 126 at an elbow thereof to facilitate assembly of the connector. In the illustrated embodiment, the pin 108 may be press fit into the insulator 106, which includes a central opening therein for receiving the pin 108. Axial placement of the pin 108 relative to the insulator 106 may be determined by engagement of a surface of the pin with a surface of the insulator 106. In the illustrated embodiment, for example, engagement of the pin 108 with the insulator 106 at point A fixes the axial location of the pin relative to the insulator.

The assembly of the pin 108 and insulator 106 may then be press fit into opening 126. The axial location of the pin and insulator within the opening 126 may be determined by engagement of a surface of the insulator with a surface of the body 120. In the illustrated exemplary embodiment, engagement of the insulator with the body at point B fixes the axial locations of the pin and insulator relative to the body. Once the pin 108 and insulator 106 are assembled through opening 126, the cover 110 may be press fit over the opening to prevent contaminants from entering the opening.

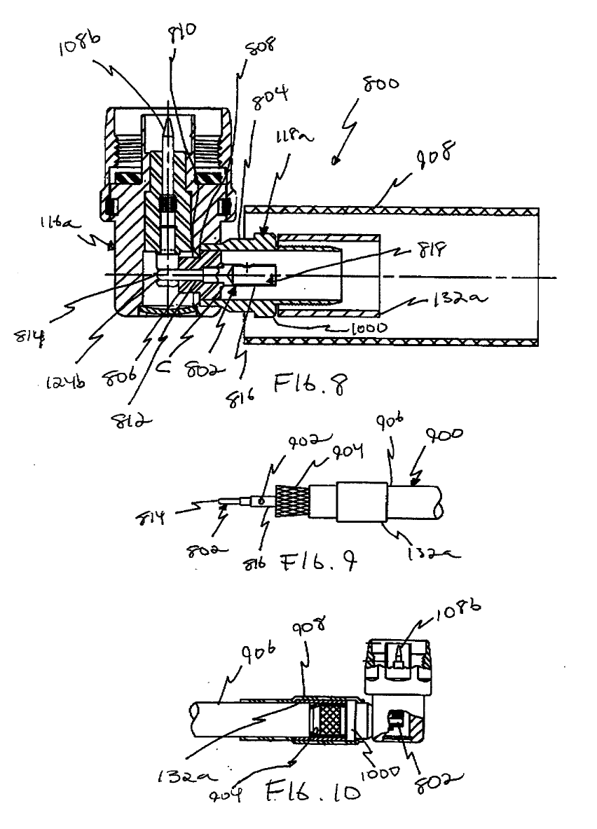

The engaging surfaces between the pin, insulator, and body may be positioned so that, when assembled, the opening 124 is generally in axial alignment with a cable receiving opening 128 of the cable receptacle portion 118, as shown particularly in FIG. 3. With reference also to FIG. 7, the cable center conductor 706, or an adapter pin affixed thereto, may enter the opening 124 in the pin 108 via the cable receiving opening 128.

The cable receptacle portion may 118 be dimensioned to allow a cable braid of the coaxial cable to be installed over the exterior surface 130, which may be knurled to resist axial movement of the braid relative to the portion 118. The end 122 may be tapered to facilitate installation of the braid over the surface 130. As shown, for example, in FIG. 7, when the cable center conductor is positioned in the opening 124 and the braid 700 is positioned over the exterior surface, a crimp sleeve 132 may be compressed over the braid and over an end the cable jacket 702 to secure the cable 704 to the connector 100.

The coupling nut 104 may be affixed to the body by installing the retaining gasket 112 in associated annular slot 134 in the body and then positioning the nut over the body and gasket, until the gasket engages an associated slot 134 in the nut 104. The coupling nut, of course, facilitates removable connection of the connector 100 with a mating connector to make electrical contact between the pin 108 and a center conductor pin of the mating connector. A variety of coupling mechanisms will be known to those skilled in the art. It is to be understood, therefore, that the present invention is not limited to the illustrated coupling nut or coupling mechanism. Also, although the illustrated embodiment is configured as a plug-type connector, those skilled in the art will recognize that the advantages of the present invention may also be incorporated in a receptacle-type connector.

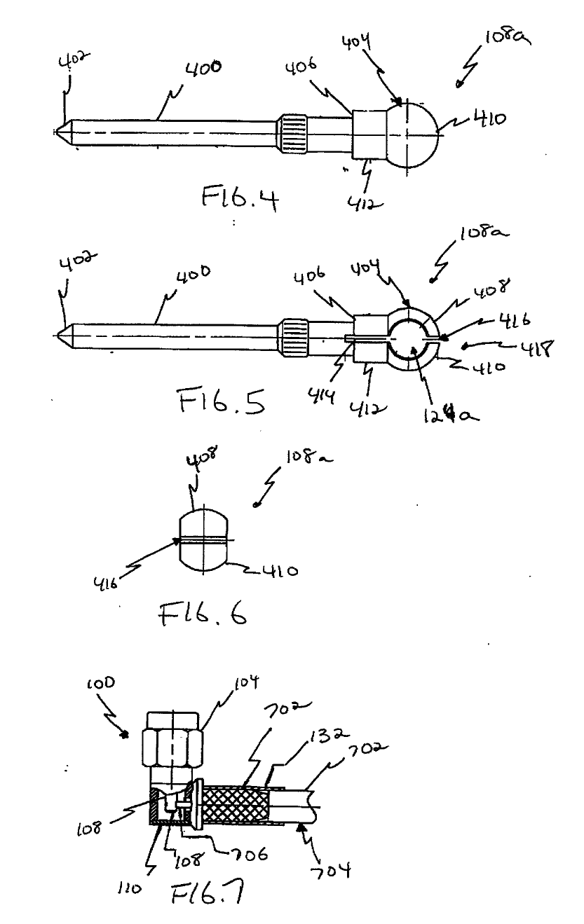

Those skilled in the art will also recognize that the center conductor pin may be provided in a variety of configurations. FIGS. 4-6 illustrate an exemplary center conductor pin 108a consistent with the invention. In the illustrated exemplary embodiment, the pin 108a includes: an elongate shaft 400 terminating in a beveled end 402; a receptacle structure 404 having portions defining an opening 124a; and a shoulder 406 for establishing the axial position of the pin relative to an insulator by engagement of a surface on the insulator. The beveled end 402 is configured for making electrical contact with a center conductor (not shown) of a connector that mates with the connector in which the pin 108a is installed.

In the illustrated embodiment the receptacle structure includes first 408 and second 410 generally semi-spherical portions connected to a body 412 portion of the pin. The body portion 412 includes a slot 414 formed therein. The first semi-spherical portion 408 extends from the body portion 412 on one side of the slot 414, and the second semi-spherical portion 410 extends from the body portion on another side of the slot 414. An end slot 416 is provided between the portions 408 and 410 at the receptacle end 418 of the pin, generally in alignment with the slot 414.

The end slot 416 and the slot 414 allow expansion of the opening 124a for receiving a cable center conductor 700 or an adapter pin affixed thereto. In one embodiment, the opening 124a may be dimensioned to have a diameter slightly less than the cross-sectional diameter of the cable center conductor 700 or adapter pin. In this configuration, when the center conductor pin or adapter enters the opening 124a, the slots 414 and 416 allow expansion of the opening and establish a spring tension of the portions 408 and 410 against the pin or adapter. A reliable electrical connection between the pin 108a and the center conductor pin or adapter is thus formed.

Those skilled in the art will recognize that the end structure 404 may be provided in a variety of configurations. In the illustrated embodiment, the end structure extends axially from the body to define an opening 124a having an axis that is generally perpendicular to the axis of the center conductor pin. The end structure may, however, extend radially, or from a side surface of the pin, to allow a shorter overall length for the center conductor pin. In such an embodiment, the opening may have an axis that is angularly oriented, e.g. perpendicular, to the axis of the center conductor pin, or the opening may be axially aligned with the center conductor pin in a straight or in-line connector embodiment. In addition, the shape and size of the receptacle structure may be chosen to electrically compensate for a matched electrical line.

Turning now to FIG. 8, there is illustrated an exemplary embodiment 800 of the present invention including an adapter pin 802. In the illustrated embodiment, a cable receptacle portion 118a of the connector 800 is joined to a separate connector portion 116a by a press fit connection. The cable receptacle portion 118a includes an outer shell 804 and an insulator 806. The end surface 808 of the outer shell engages an abutment 810 on the connector portion 116a to fix the position of the connector portion relative to the receptacle portion 118a.

The insulator 806 includes a central opening 812 for removably receiving the adapter pin 802. Engaging surfaces of the insulator and the adapter pin, e.g. at point C, fix the axial position of the adapter pin 802 relative to the insulator 806 to allow extension of the adapter pin 802 into the opening 124b of the center conductor pin 108b. As shown, the insulator 806 may extend inward to contact, or be in close proximity to, the center conductor pin 108b.

Generally, the adapter pin 802 has a first end 814 dimensioned to extend into the opening 124b in the center conductor pin 108b with a press fit, as shown in FIGS. 8 and 10. A second end 816 of the adapter pin is includes an opening 818 dimensioned for receiving a center conductor of the coaxial cable. As shown in FIG. 9, for example, the adapter pin 802 may be affixed to a center conductor of the cable 900 by inserting the cable center conductor into opening 818 in the end 816 of the adapter pin. The adapter pin may include a solder opening 902 through an exterior surface thereof in communication with the opening 818 for receiving the cable center conductor. When the center conductor is installed in the opening 818, the adapter pin may be soldered to the center conductor by inserting solder into the solder opening 902.

Once the pin is affixed to the center conductor, the cable may be installed to the connector 800 by inserting the end 814 of the pin into the opening 124b in the center conductor pin, and placing the cable braid 904 over the exterior surface 130a of the portion 118a. A crimp sleeve 132a may then be compressed against the braid 904 and the cable jacket 906. A shrink-wrap dielectric 908, of the type known to those skilled in the art, may then be installed over the crimp sleeve 132a, over a projection 1000 on the portion 118a, and over a further portion of the cable jacket 906.

Advantageously, an embodiment including an adapter pin allows use of a connector assembly consistent with the invention with a variety of coaxial cable sizes. To accommodate different cable sizes, an adapter pin dimensioned to receive the cable center conductor is chosen and secured to the cable center conductor. Electrical connection between the center conductor pin and the cable center conductor is then made by simply press fitting the end 814 of the adapter pin into the opening 124b in the center conductor pin.

There is thus provided an electrical connector that allows for facile and reliable assembly of a coaxial cable to the connector. The embodiments that have been described herein, however, are but some of the several which utilize this invention and are set forth here by way of illustration but not of limitation. For example, although the invention is described herein with a right angle coaxial connector, it will be readily apparent to those skilled in the art that the features of the present invention could be incorporated into a wide variety of connector designs, e.g. straight or angular connectors, triaxial connectors, etc. It is obvious that many other embodiments, which will be readily apparent to those skilled in the art, may be made without departing materially from the spirit and scope of this invention.

What is claimed is:

1. An electrical connector for transmission line cable, said connector comprising:
a body comprising a connector end configured to mate with a mating connector and a cable receptacle end having a cable opening therein for receiving at least a portion of said cable; and
a center conductor pin disposed in said body, said center conductor pin comprising a receptacle structure having portions defining a receptacle opening extending therethrough, said opening being aligned with said cable opening and being dimensioned for receiving a conductor to make electrical contact between said conductor and said center conductor pin.

2. An electrical connector according to claim 1, wherein said body comprises a cable receptacle portion extending from a connector portion at a right angle, and wherein a first end of said cable receptacle portion is said cable receptacle end of said body and a first end of said connector portion is said connector end.

3. An electrical connector according to claim 2, wherein said connector portion includes an assembly opening at a second end thereof.

4. An electrical connector according to claim 1, wherein said receptacle opening is axially aligned with said cable opening.

5. An electrical connector according to claim 1, wherein said receptacle opening has an axis that is angularly oriented to an axis of said center conductor pin.

6. An electrical connector according to claim 1, wherein said receptacle opening has an axis that is substantially perpendicular to an axis of said center conductor pin.

7. An electrical connector according to claim 1, wherein said receptacle opening is defined between first and second semi-spherical portions extending from a body of said center conductor pin.

8. An electrical connector according to claim 7, wherein said first and second semi-sperical portions are separated by a slot.

9. An electrical connector according to claim 1, wherein said receptacle structure is at a first end of said center conductor pin, and wherein a second end of said center conductor pin is configured to make electrical contact with a center conductor of a mating connector.

10. An electrical connector according to claim 1, wherein said cable is a coaxial cable, and wherein said conductor comprises a center conductor of said coaxial cable.

11. An electrical connector according to claim 1, wherein said conductor comprises an adapter pin for making electrical contact with a center conductor of said cable.

12. An electrical connector for a coaxial cable, said connector comprising:
a body including a connector portion configured to mate with a mating connector and a cable receptacle portion having a cable opening therein for receiving at least a portion of said coaxial cable, said connector portion being configured at a right angle to said cable receptacle portion; and
a center conductor pin disposed in said connector portion, said center conductor pin comprising a receptacle structure having portions defining an opening extending therethrough, said opening being substantially axially aligned with said cable opening and being dimensioned for receiving a conductor to make electrical contact between said conductor and said center conductor pin.

13. An electrical connector according to claim 12, wherein said receptacle opening is defined between first and second semi-spherical portions extending from a body of said center conductor pin.

14. An electrical connector according to claim 13, wherein said first and second semi-spherical portions are separated by a slot.

15. An electrical connector according to claim 12, wherein said receptacle structure is at a first end of said center conductor pin, and wherein a second end of said center conductor pin is configured to make electrical contact with a center conductor of a mating connector.

16. An electrical connector according to claim 12, wherein said conductor comprises a center conductor of said coaxial cable.

17. An electrical connector according to claim 12, wherein said conductor comprises an adapter pin for making electrical contact with a center conductor of said coaxial cable.

18. An electrical connector according to claim 12, wherein said connector portion includes an assembly opening at a second end thereof.

19. A method of electrically connecting a cable connector to a transmission line cable, said method comprising:
providing said connector with a connector body comprising a cable receptacle end having a cable opening therein for receiving at least a portion of said cable;
providing a center conductor pin in said body, said center conductor pin comprising a receptacle structure having portions defining a receptacle opening extending therethrough; and
inserting said center conductor of said cable into said receptacle opening through said cable opening.

20. A method of electrically connecting a cable connector to a transmission line cable comprising:
electrically connecting a first end of an adapter pin to a center conductor of said cable;
providing said connector with a connector body comprising a cable receptacle end having a cable opening therein for receiving at least a portion of said cable;
providing a center conductor pin in said body, said center conductor pin comprising a receptacle structure having portions defining a receptacle opening extending therethrough, said receptacle opening being configured to receive a second end of said adapter pin; and
inserting said adapter pin into said receptacle opening through said cable opening.
